(19) United States
(12) Patent Application Publication
(10) Pub. No.: US 2005/0237969 A1
(43) Pub. Date: Oct. 27, 2005

(54) Apparatus and method for producing a tunnel in an integrated serving general packet radio service (GPRS) service node (SGSN) and gateway GPRS support node (GGSN) in a universal mobile telecommunication service (UMTS) network

(75) Inventors: Tae-Sung Jung, Suwon-si (KR); Jae-Hyuck Kim, Suwon-si (KR); Jong-Seok Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/110,687

(22) Filed: Apr. 21, 2005

(30) Foreign Application Priority Data
Apr. 24, 2004 (KR) 2004-28466

(51) Int. Cl. H04B 7/00

(52) U.S. Cl. 370/328

(57) ABSTRACT

An apparatus and a method are provided for producing a tunnel in an integration serving node formed by integrating a serving support node and a gateway node which connect a radio network controller of a wireless access network server to a home server of an external network. The apparatus comprises a plurality of integration traffic modules for processing upstream data and downstream data; a memory module comprising a look up table, for example, for storing integration tunnel endpoint identifiers corresponding to the integration traffic modules; a serving support node signaling module for, according to a call request of a terminal for connecting with an external server, selecting one integration traffic module from among the plurality of integration traffic modules and assigning an integration tunnel endpoint identifier corresponding to the selected integration traffic module; and a gateway node signaling module for receiving request data including the assigned integration tunnel endpoint identifier from the serving support node signaling module though internal processing communication (IPC) and storing the integration tunnel endpoint identifier in the look up table.

### PRIORITY

This application claims the benefit under 35 U.S.C. 119(a) of an application entitled “Apparatus and Method for Producing Tunnel in Integrated SGSN and GGSN in UTMS Network” filed in the Korean Intellectual Property Office on Apr. 24, 2004 and assigned Serial No. 2004-28466, the entire contents of which are incorporated herein by reference.

### BACKGROUND OF THE INVENTION

1. Field of the Invention

The present invention relates to a serving general packet radio service (GPRS) support node (SGSN) and a gateway GPRS support node (GGSN) in a universal mobile telecommunication system (UMTS) network, and more particularly to a method for establishing a tunnel by integrating an SGSN and a GGSN.

2. Description of the Related Art

FIG. 1 is a schematic block diagram illustrating a structure of a conventional UMTS network.

The UMTS network includes a Node B 110 connected to a mobile station (MS) 100 for requesting a specific service, a radio access network (RAN) 118 comprising a radio network controller (RNC) 120 for controlling the Node B 110, and a core network (CN) 124. The CN 124 comprises a service GPRS support node (SGSN) 130 and a gateway GPRS support node (GGSN) 140. A user using the MS 100 can receive data stored in a data server of an external network such as a packet data network (PDN) for the SGSN 130 through the UMTS network.

The SGSN 130 denotes a serving node of a general packet radio service (GPRS) for delivering packets transmitted/received from/in the MS 100 in a management domain. The SGSN 130 manages a packet data mode service of the MS 100 by establishing a mobile management context for a packet mode of the MS 100. In other words, the SGSN 130 performs functions comprising packet routing and delivering and mobility management (such as attach, detach, and location management), logical link management, and authentication and accounting. In addition, the SGSN 130 establishes a packet data protocol (PDP) context and delivers a service data unit (SDU) through GPRS tunneling protocol (GTP) tunneling for processing the mobility of the MS 100 using packets and for supporting registration and authentication of the MS 100 using packets.

The GGSN 140 represents a GPRS gateway node positioned between a GPRS backbone network and an external packet data network (PDN) 150 and directly connected to the PDN 150. The GPRS performs tunneling and Internet protocol (IP) routing functions by maintaining routing information with respect to the SGSN 130. The GGSN 140 is connected to the SGSN 130 through a Gn interface.

Herein, the routing information denotes information for delivering a packet to a desired SGSN/GGN or a desired external network based on a destination address in an IP header of the packet. In addition, the routing information comprises a table created by a routing protocol. Accordingly, a packet transmitted from the SGSN 130 is converted into a suitable packet data protocol (PDP) form through the GGSN 140 and sent to the PDN 150. In contrast, a packet transmitted from the external PDN 150 may undergo a reverse procedure. At this time, the GGSN 140 attaches IP/user datagram protocol (UDP)/GTP headers to the IP packet transmitted from the external PDN 150 by using encapsulation and removes the IPIUDP/GTP headers from the IP packet transmitted from the SGSN 130 by using de-capsulation.

The GGSN 140 must be aware of a current SGSN managing the MS 100 in order to send a packet transmitted from the external PDN 150 to the MS 100. Accordingly, the GGSN 140 stores a user profile and information about a current SGSN of the user in the PDP context. In addition, the GGSN 140 performs IP address assignment to the MS, management, point-to-point protocol (PPP) creation, termination and relaying, and screening for connection service with an Internet service provider (ISP) or another ISP as main functions.

Generally, a GGSN has a many-to-many relationship to an SGSN. One GGSN may be used as an interface between a plurality of SGSNs and one PDN. In contrast, one SGSN may use a plurality of GGSNs in order to send a packet to different PDNs.

A UMTS network is linked with the PDN or Internet 150. At this time, a GGSN acts as a router in relation to a Gi interface and Internet. The GGSN manages a database called a “PDP context”. The GGSN provides a packet service based on the database.

Since the conventional mobile communication system operating as described above must pass through many nodes such as an SGSN and a GGSN, the network structure is complex. Therefore, a network structure capable of efficiently transmitting data is required. Such a requirement is relatively strong in a UMTS network in which an amount of transmitted data is expected to increase according to the supply of various services.

Accordingly, there is a requirement for a mobile communication network and a call administration method in which a module for processing user traffic is incorporated in an IGSN obtained by integrating the SGSN and GGSN, thereby eliminating unnecessary network components, reducing unnecessary traffic, and reducing the load of the mobile communication network.

### SUMMARY OF THE INVENTION

Accordingly, the present invention has been made to solve the above-mentioned problems occurring in the prior art, and an object of the present invention is to provide an apparatus and a method for improving the efficiency of a call establishment process by integrating a serving general packet radio service (GPRS) support node (SGSN) with a gateway GPRS support node (GGSN).

It is another object of the invention to provide an apparatus and a method for providing a tunnel between a radio network controller (RNC) and an integrated SGSN and GGSN.

To accomplish the above objects, there is provided an apparatus for providing a tunnel in an integration serving node formed by integrating a serving support node and a gateway node which connect a radio network controller of a wireless access network server to a home server of an external network. The apparatus comprises a plurality of integration traffic modules for processing upstream data and downstream data, a look up table for storing integration tunnel endpoint identifiers corresponding to the integration traffic modules, a serving support node signaling module for, according to a call request of a terminal for connecting with an external server, selecting one integration traffic module from among the plurality of integration traffic modules and assigning an integration tunnel endpoint identifier corresponding to the selected integration traffic module, and a gateway node signaling module for receiving request data including the assigned integration tunnel endpoint identifier from the serving support node signaling module though internal processing communication (IPC) and storing the integration tunnel endpoint identifier in the look up table.

According to another aspect of the present invention, there is provided a method for providing a tunnel by an integration serving node formed by integrating a serving support node and a gateway node which connect a radio_network controller of a wireless access network server to a home server of an external network. The method comprises the steps of receiving a connection request message for connecting with an external server from a terminal through the radio network controller, selecting an integration traffic module in response to the connection request message and assigning an integration tunnel endpoint identifier corresponding to the integration traffic module, storing the integration tunnel endpoint identifier in a look up table, inserting the integration tunnel endpoint identifier and a port address of an integration serving node connected with the radio network controller into a radio access bearer (RAB) request message and transmitting the radio access bearer request message to the radio network controller, and receiving a port address and an identifier of the radio network controller from the radio network controller and storing the port address and the identifier of the radio network controller.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view illustrating a structure of a conventional universal mobile telecommunication system (UMTS) network;

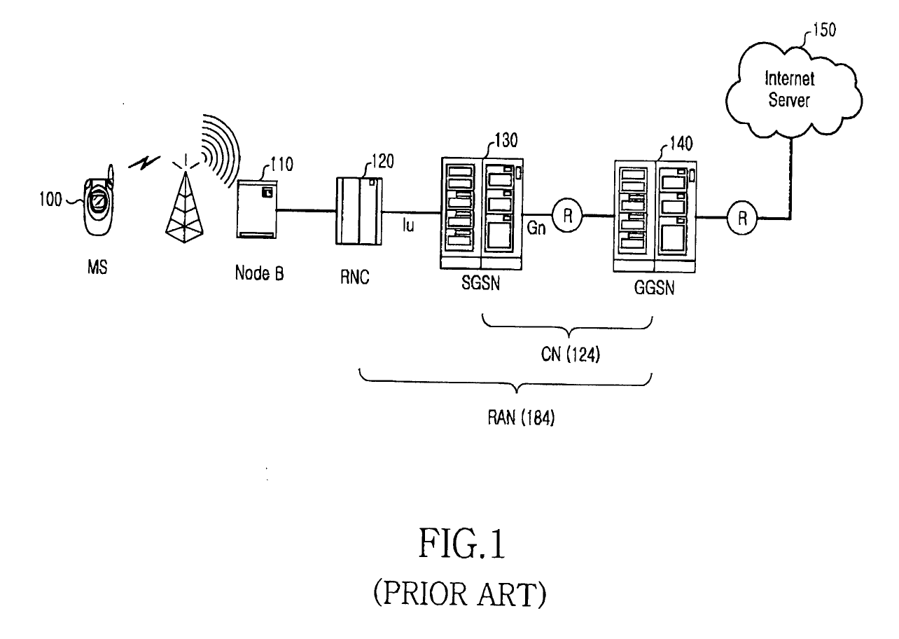

FIG. 2 is a flowchart illustrating a conventional packet data protocol (PDP) activating procedure;

FIG. 3 is a diagram illustrating a data traffic structure of a UMTS network formed by performing a conventional call procedure shown in FIG. 2;

FIG. 4 is a diagram illustrating a structure of a UMTS system including an integrated GSPR service node (IGSN) formed by integrating a serving general packet radio service (GPRS) support node (SGSN) with a gateway GPRS support node (GGSN) according to an embodiment of the present invention;

FIG. 5 is a diagram illustrating a structure of an IGSN according to an embodiment of the present invention;

FIG. 6 is a diagram illustrating a data traffic structure of a UMTS system including an IGSN according to an embodiment of the present invention; and

FIG. 7 is a flowchart illustrating a call connection procedure according to an embodiment of the present invention.

### DETAILED DESCRIPTION OF AN EXEMPLARY EMBODIMENT

Hereinafter, an embodiment of the present invention will be described in detail with reference to the accompanying drawings. In the following description of the present invention, a detailed description of known functions and configurations incorporated herein will be omitted for conciseness.

According to an embodiment of the present invention, an integrated SGSN and GGSN reduce their roles and signaling procedures between them, thereby providing a more efficient system. Prior to providing a description of the present invention, a method for producing a tunnel of the integrated serving general packet radio service (GPRS) support node (SGSN) and gateway GPRS support node (GGSN) according to an embodiment of the present invention will be described based on the functions of both the SGSN and the GGSN in a conventional packet data protocol (PDP) activating procedure.

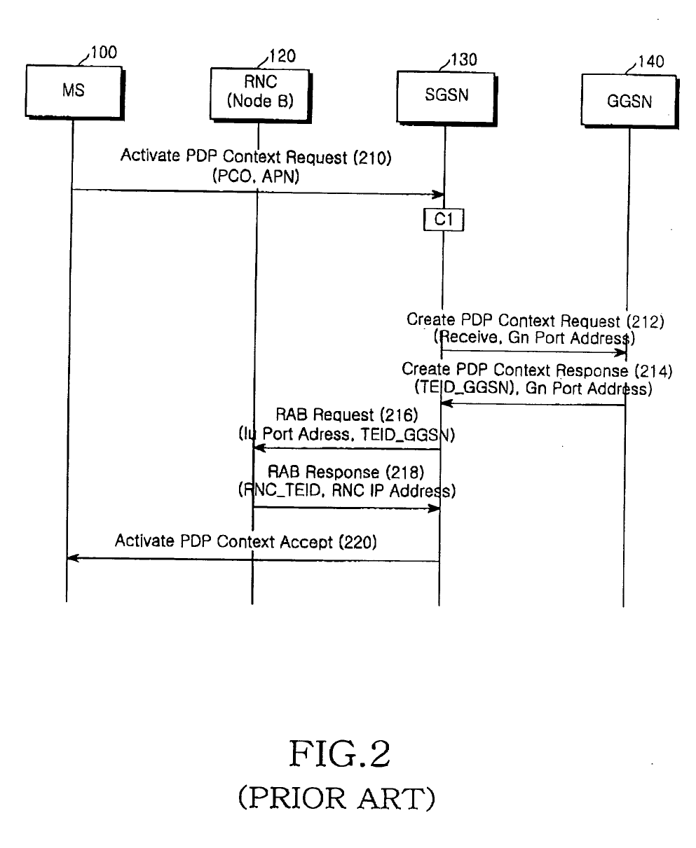

FIG. 2 is a flowchart illustrating the conventional PDP activating procedure.

As shown in FIG. 2, a mobile station (MS) 100 sends an Activation PDP Context Request (APCQ) message for connection with an external network to an SGSN 130 in step 210. Herein, the APCQ message comprises a protocol configuration option (PCO) containing protocol information and an access point name (APN). At this time, only a minimum required air channel is ensured between the MS 100 and a radio network controller (RNC) 120.

In step 212, the SGSN 130 creates a GTP tunnel between the SGSN 30 and a specific GGSN 140 indicated by the APN from among a plurality of GGSNs for the requested PDP context in response to the APCQ message. Herein, the APN refers to an identifier for distinguishing a specific service. The SGSN 130 acquires a corresponding GGSN address based on the APN. The SGSN 130 checks a QoS bandwidth for the GTP tunnel so as to secure resources and assigns a tunnel endpoint identifier (TEID_SGSN). Then, the SGSN 130 searches a routing table for the GGSN address to find a Gn port address according to its own Gn interface having the lowest cost. Also, the SGSN 130 locates an Iu port address according to an Iu Interface between the RNC 120 and the SGSN by using a RNC_ID transmitted from the RNC 120. After that, the SGSN 130 inserts the Gn port address and the TEID_SGSN assigned by the SGSN 130 into a Create PDP context Request (CPCQ) message and transmits the CPCQ message to the GGSN 140 in response to the APCQ message.

In step 214, the GGSN 140 performs an authentication procedure with an external server 150 according to the APN in response to the CPCQ message and obtains a PDP address to be used by the MS according to types of services. Herein, the PDP address denotes an address of an Internet host server providing a service requested by the MS and can be assigned by GGSNs or external servers such as DHCPs. After that, the GGSN 140 inserts a tunnel endpoint identifier TEID_GGSN assigned by the GGSN 140 and a Gn port address according to its own Gn interface into a Create PDP Context Response (CPCR) message and sends the CPCR message to the SGSN 130.

In step 216, the SGSN 130 sends a radio access bearer (RAB) Request message to the RNC 120 in order to create a tunnel with the RNC 120. Herein, the RAB Request message comprises the Iu port address and the TEID_SGSN.

In step 218, the RNC 120 secures an air channel according to the Quality of Service (QoS) required by the SGSN 130 in response the RAB request message and inserts a tunnel endpoint identifier TEID_RNC assigned by the RNC 120 and an IP address of an RNC requiring a service into a RAB response message so as to send the RAB response message to the SGSN 130.

After steps 210 to 218 are successfully completed, the SGSN 130 sends an Activate PDP Context Accept message to the MS 100.

From this time, the MS 100 can receive a packet service from a server requested by the MS 100 and establish communication with an external Internet host server. Traffic is transmitted through the air channel between the MS and the RNC and through GTP tunnels between the RNC and the SGSN and between the SGSN and the GGSN generated in the procedure. Herein, the GGSN 140 creates and releases the GTP tunnels.

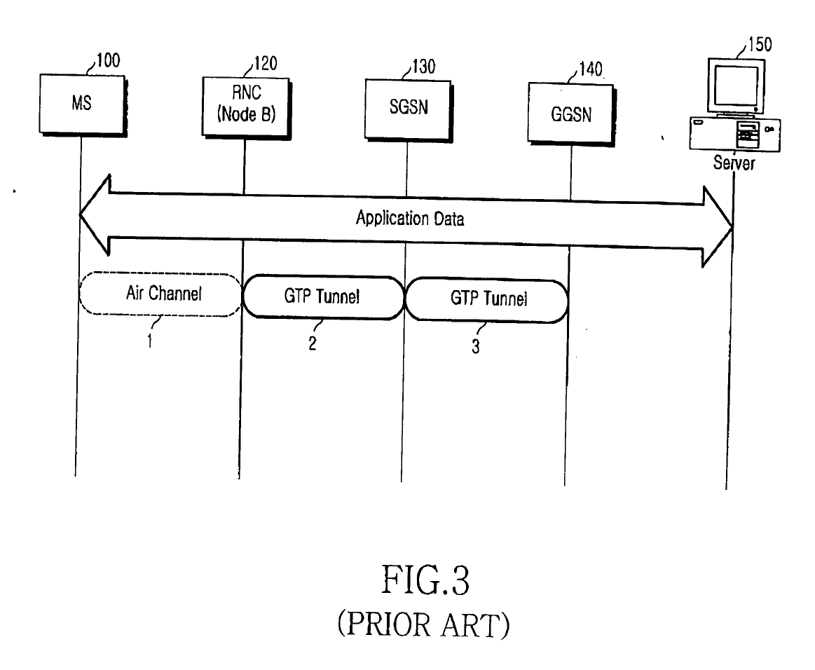

FIG. 3 is a view showing a data traffic structure of a UMTS network formed by performing the conventional call procedure shown in FIG. 2.

An air channel 1 is created between the MS 100 and the RNC 120, a GTP tunnel 2 is created between the RNC 120 and the SGSN 130, and a GTP tunnel 3 is created between the SGSN 130 and the GGSN 140. The MS 100, the RNC 120, the SGSN 130, and the GGSN 140 create and deliver tunnel endpoint identifiers TEIDs and addresses for distinguishing nodes connected in order to create each tunnel. At this time, methods for assigning the TEIDs vary depending on communication nodes. This implies that the TEIDs assigned by the communication nodes have different formats. However, a general format of the TEIDs comprises a traffic module number and a call identifier Call_ID of a corresponding traffic module.

An embodiment of the present invention provides a method for performing a PDP activation procedure for call establishment in an integrated GPRS serving node (IGSN) formed by integrating an SGSN with a GGSN for performing a call processing procedure for providing a specific service to the MS.

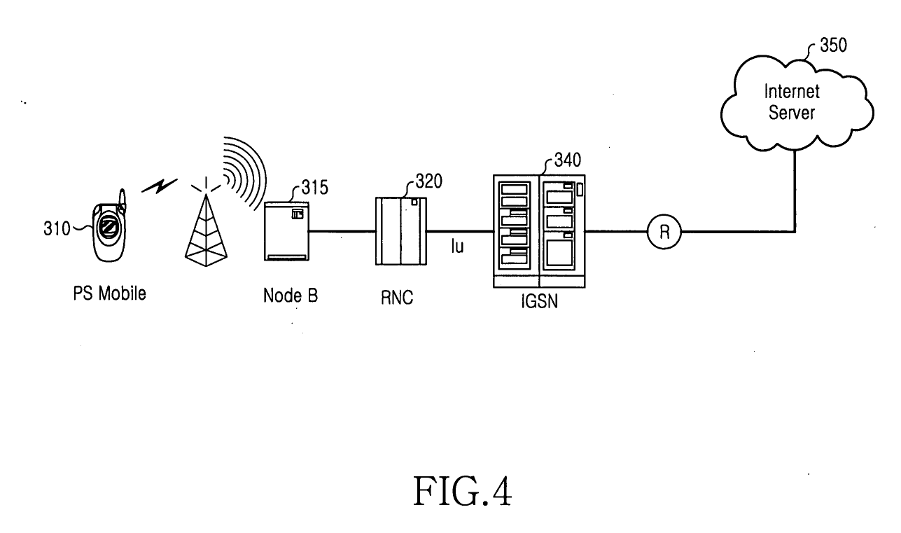

FIG. 4 is a view illustrating a structure of a UMTS system including an IGSN formed by integrating an SGSN with a GGSN according to an embodiment of the present invention. As shown in FIG. 4, the UMTS system comprises a Node B 315 connected to a mobile station (MS) 310, a radio network controller 320 (RNC), and an external server 350. Terminal equipment including personal computers (PCs) and notebooks can employ a wireless interface through the MS 310. The MS 310 is connected to a visitor location register (VLR) (not shown) through the Node B 315 and the RNC 320 for receiving a circuit service based on voice.

The MS 310 is connected to the IGSN 340 through the RNC 320 for receiving a packet service. Herein, an interface between the RNC 320 and the IGSN 340 is called “Iu”. Although it is not shown, the Node B and the RNC 320 may be constructed as a plurality of Node Bs and a plurality of RNCs, and the IGSN 340 may be connected to the VLR through an interface named “Gs”. The IGSN 340 establishes communication with other SGSNs (not shown) through an interface named “Gn” (not shown) and is connected to the packet data network 350 such as the Internet including another TE through a GGSN (not shown) linked by means of the Gn interface.

The IGSN 340 refers to a node integrating a session management function, a mobility management function, a radio access network application protocol (RANAP) processing function, a GPRS tunneling protocol (GTP) processing function, a MAP processing function, a Multichannel Interface Processor (MIP) interface function, an operation and maintenance function, an IP address assignment function and a domain function, which have been separately processed based on SGSN functions and GGSN functions.

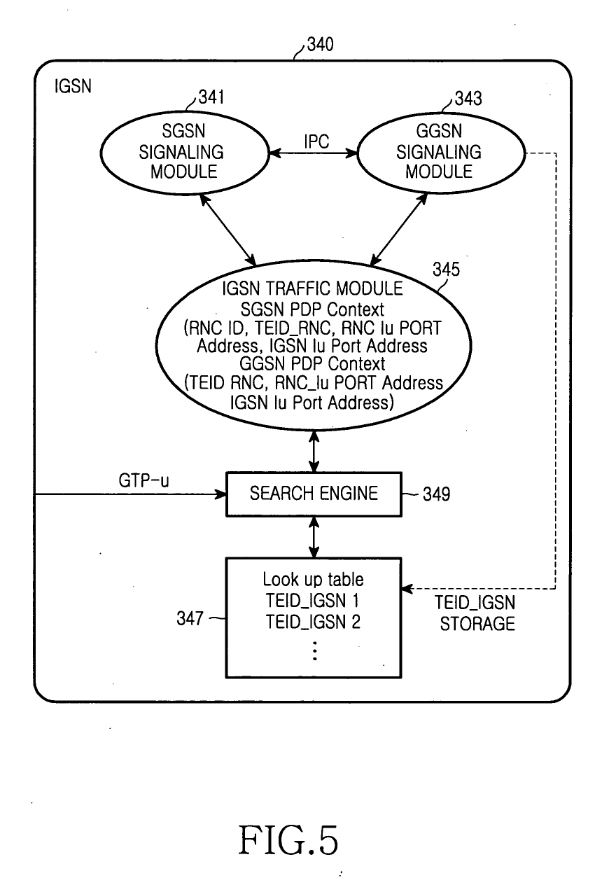

FIG. 5 is a view illustrating a structure of the IGSN 340 according to an embodiment of the present invention.

The IGSN 340 comprises a SGSN signaling module 341 for processing SGSN signaling according to user input, a GGSN signaling module 343 for transmitting/receiving a control signal to/from the SGSN signaling module 341 through Internet processing communication (IPC), an integrated IGSN traffic module 345 for processing all traffic, a look up table 347 for storing tunnel endpoint identifiers TEID_IGSNs assigned by the IGSN 340, and a search engine 349 for searching for tunnel endpoint identifiers TEIDs in the look up table 347.

If the SGSN signaling module 341 receives a PDP activation request from the MS through an RNC, the SGSN signaling module 341 selects the traffic module 345 having the least amount of traffic load from among a plurality of traffic modules. Then, the SGSN signaling module 341 stores a TEID_IGSN according to the selected traffic module 345 in the look up table 347 and transmits the TEID_IGSN to the GGSN signaling module 343 through the IPC. Herein, the TEID_IGSN comprises the selected traffic module number and a call identifier call_ID.

The traffic module 344 creates control signals for the SGSN signaling module 341 and the GGSN signaling module 343 and the SGSN PDP context and the GGSN PDP context according to the TEID_IGSN. The SGSN PDP context comprises an ID of the RNC, an RNC_TEID, an Iu port address of the RNC, and an Iu port address of the IGSN connected to the RNC in addition to an SGSN_TEID and information of a Gn port address of the SGSN. The GGSN PDP context comprises a RNC_TEID, an Iu port address of the RNC, and an Iu port address of the IGSN connected to the RNC. In addition, the GGSN PDP context comprises a RNC flag for indicating that the IGSN is directly connected to the RNC.

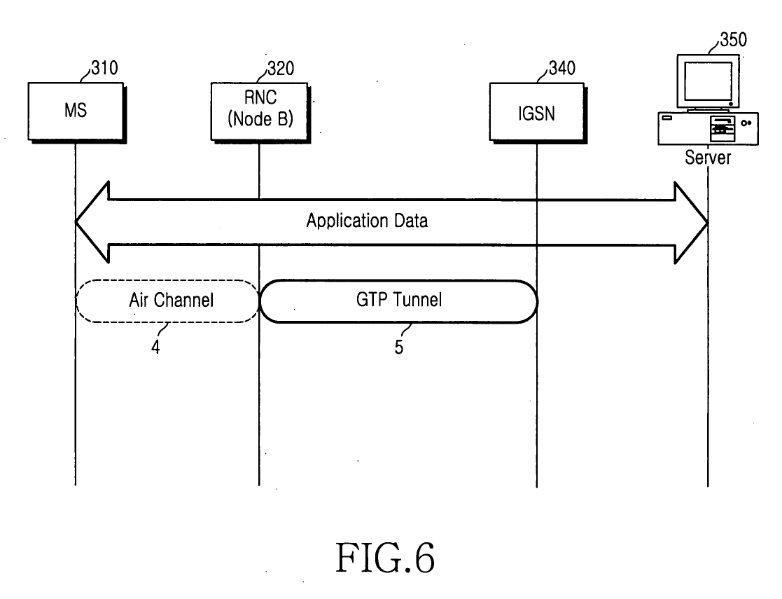

FIG. 6 is a view showing a data traffic structure of the UMTS system including the IGSN according to the present invention. As shown in FIG. 6, if a call procedure for connection between a MS 310 and the external server 350 is performed, an air channel 4 is ensured between the MS 310 and the RNC 320, and a GTP tunnel 5 for directly connecting the RNC 320 to the GGSN 340 is created. The IGSN creates the GTP tunnel 5 by assigning an integrated tunnel endpoint identifier TEID_IGSN.

If the IGSN 340 receives upstream data traffic including the TEID_IGSN from the RNC 320 after the creation of the GTP tunnel 5 between the RNC 320 and the IGSN 340, the search engine 349 finds the TEID_IGSN included in the data traffic by searching the look up table 347 and sends the data traffic to the traffic module 345 corresponding to a traffic module number of the corresponding TEID_IGSN. Then, the traffic module 345 removes an IP/UDP/GTP header from the received packet and transmits the packet to a corresponding server of an external network.

In the meantime, if the IGSN 340 receives data traffic from an external network, the search engine 349 searches for a corresponding traffic module by using a destination address of an IP header in the data traffic. If the traffic module is found, the search engine 349 sends the data traffic to the corresponding traffic module 345. Then, the traffic module 345 checks a RNC flag of a GGSN PDP context. If the flag has the state of “ON”, the traffic module 345 sets the destination address of the data traffic to an Iu port address of a RNC and sends the data traffic. If the flag has the state of “OFF”, the data traffic is transmitted to another SGSN through the conventional method.

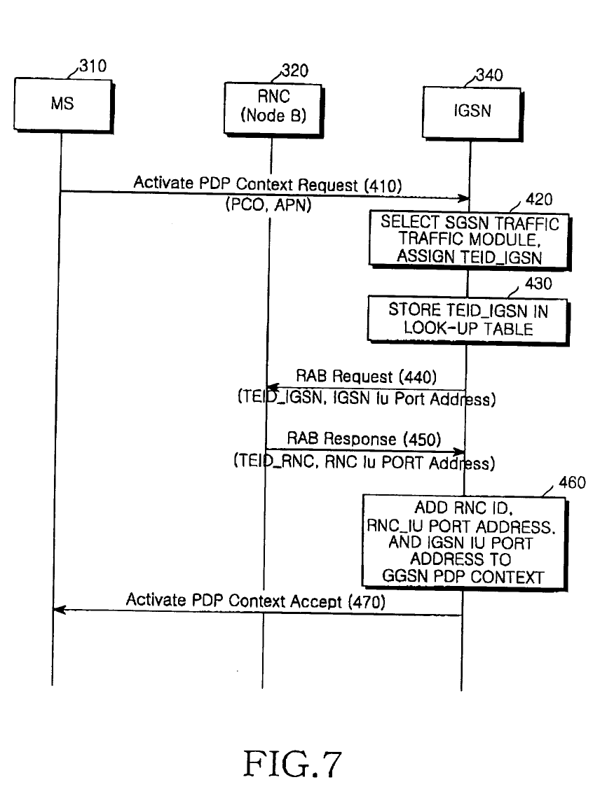

Hereinafter, a call connecting procedure for creating a GTP tunnel according to an embodiment of the present invention will be described with reference to FIG. 7.

As shown in FIG. 7, in step 410, the MS 310 sends an Activate PDP Context Request (APCQ) message to the IGSN 340 for connecting with the external server 350. Herein, the APCQ message comprises a protocol configuration option (PCO) comprising information regarding protocols and an access point name (APN). At this time, only a minimum required air channel is ensured between the MS 310 and the RNC 320.

In step 420, the IGSN 340 selects an IGSN traffic module having the least amount of traffic load and creates a SGSN PDP context while assigning a tunnel endpoint identifier TEID_IGSN in response to the APCQ message. Herein, the TEID_IGSN comprises a number of the selected traffic modules, an Iu port address, and a call identifier. The SGSN PDP context comprises an ID of a RNC, a RNC_TEID, an Iu port address of the RNC, and an Iu port address of the IGSN connected to the RNC.

In step 430, the IGSN 340 stores the TEID_IGSN in its own look up table and creates a GGSN PDP context. Herein, the GGSN PDP context comprises the RNC_TEID, the Iu port address of the RNC, the Iu port address of the IGSN connected to the RNC in addition to an SGSN_TEID and a Gn port address of a GGSN. Also, the GGSN PDP context comprises a RNC flag for indicating that the IGSN is directly connected to the RNC.

In step 440, the IGSN 340 inserts the Iu port address of the IGSN connected with the RNC and the TEID_IGSN into a RAB request message and transmits the RAB request message. In step 450, the RNC 320 transmits a RNC_TEID and an Iu port address of the RNC assigned by the RNC 320 to the IGSN 340 corresponding to the Iu port address.

In step 460, the IGSN 340 adds the RNC_TEID, the Iu port address of the RNC, and the Iu port address of the IGSN connected with the RNC to the GGSN PDP context of the IGSN 340.

In step 470, the IGSN 340 delivers an Activate PDP context Accept message to the MS 310

If steps 410 to 470 are successfully performed, the GTP tunnel is created between the RNC 320 and the IGSN 340. After that, the MS 310 can receive a packet service from a server requested by the MS 310 and establish communication with an external Internet host. Traffic is transmitted through the GTP tunnel between the RNC 320 and the IGSN 340 created in the above procedure. Lastly, the IGSN 340 controls the creation and release of the GTP tunnel.

According to an embodiment of the present invention, it is possible to prevent packet loss due to network congestion between a SGSN and a GGSN by integrating the SGSN with the GGSN. In addition, according to an embodiment of the present invention, an integrated TEID is assigned to the SGSN and the GGSN, and RNC information is stored in a GGSN PDP context by integrating the SGSN with the GGSN, so that it is possible to directly connect in the procedure the IGSN to the RNC.

While the invention has been shown and described with reference to a certain embodiment thereof, it will be understood by those skilled in the art that various changes in form and details may be made therein without departing from the spirit and scope of the invention. Consequently, the scope of the invention should not be limited to the embodiment, but should be defined by the appended claims and equivalents thereof.

1. An apparatus for producing a tunnel in an integration serving node formed by integrating a serving support node and a gateway node which connect a radio network controller of a wireless access network server to a home server of an external network, the apparatus comprising:
a plurality of integration traffic modules for processing upstream data and downstream data;
a memory module for storing integration tunnel endpoint identifiers corresponding to the integration traffic modules;
serving support node signaling module for, according to a call request of a terminal for connecting with an external server, selecting one integration traffic module from among the plurality of integration traffic modules and assigning an integration tunnel endpoint identifier corresponding to the selected integration traffic module; and
a gateway node signaling module for receiving request data including the assigned integration tunnel endpoint identifier from the serving support node signaling module though internal processing communication (IPC) and storing the integration tunnel endpoint identifier in the look up table.

2. The apparatus as claimed in claim 1, further comprising a search engine for searching the look up table for an integration traffic module corresponding to the integration tunnel endpoint identifier if upstream data comprising the integration tunnel endpoint identifier are received and delivering the upstream data to the integration traffic module.

3. The apparatus as claimed in claim 2, wherein the integration traffic module changes a destination address of the upstream data into an IP address of a host server providing a service requested by a user to transmit the upstream data to the host server in an external network.

4. The apparatus as claimed in claim 1, wherein the integration traffic module creates a serving support node packet data protocol (PDP) context comprising an identifier and a port address of the radio network controller and a port address of an integration serving node connecting with the radio network controller by control of the serving support node signaling module.

5. The apparatus as claimed in claim 1, wherein the integration traffic module creates a gateway node packet data protocol (PDP) context comprising a port address of the radio network controller, a port address of an integration serving node connected with the radio network controller, and a flag representing whether the radio network controller is directly connected with the integration serving node by control of the gateway node signaling module.

6. The apparatus as claimed in claim 1, wherein the integration end tunnel identifier comprises a selected integration traffic module number and a call identifier.

7. The apparatus as claimed in claim 1, wherein the integration tunnel endpoint identifiers corresponding to the integration traffic modules comprise a look up table.

8. A method for producing a tunnel in an integration serving node formed by integrating a serving support node and a gateway node which connect a radio network controller of a wireless access network server to a home server of an external network, the method comprising the steps of:
receiving a connection request message for connecting with an external server from a terminal through the radio network controller;
selecting an integration traffic module in response to the connection request message and assigning an integration tunnel endpoint identifier corresponding to the integration traffic module;
storing the integration tunnel endpoint identifier in a memory module;
inserting the integration tunnel endpoint identifier and a port address of an integration serving node connected with the radio network controller into a radio access bearer (RAB) request message and transmitting the radio access bearer request message to the radio network controller; and
receiving a port address and an identifier of the radio network controller from the radio network controller and storing the port address and the identifier of the radio network controller.

9. The method as claimed in claim 8, wherein the integration tunnel endpoint identifier comprises an integration traffic module number and a call identifier.

10. The method as claimed in claim 8, further comprising the steps of:
if upstream data traffic including the integration tunnel endpoint identifier is transmitted from the radio network controller, searching the look up table and detecting an integration identifier located in the upstream data traffic;
delivering the upstream data traffic to an integration traffic module corresponding to an integration traffic module number of the integration tunnel endpoint identifier; and
changing by the integration traffic module a destination address of the upstream data traffic into an IP address of a host server providing a service requested by a user to transmit the upstream traffic data to the host server in an external network.

11. The method as claimed in claim 8, wherein, if downstream data to be transmitted to the terminal exist, an RNC flag in a gateway node packet data protocol (PDP) context of a traffic module corresponding to the downstream data is checked, and then, if the RNC flag has a state of ‘ON’, a destination address of the downstream data is set to a port address of the radio network controller and transmitted.

12. The method as claimed in claim 8, further comprising a step of creating a serving support node packet data protocol (PDP) context comprising, the integration tunnel endpoint identifier, an identifier and a port address of the radio network controller, and a port address of an integration serving node connected with the radio network controller.

13. The method as claimed in claim 8, further comprising a step of creating a gateway node packet data protocol (PDP) context comprising the integration tunnel endpoint identifier, a port address of the radio network controller, a port address of an integration serving node connected with the radio network controller.

14. The method as claimed in claim 13, wherein the gateway node packet data protocol context further comprises a flag representing whether the integration serving node is directly connected with the radio network controller.

15. The method as claimed in claim 8, wherein the storing step further comprises:
storing the integration tunnel endpoint identifier in a look up table.
